(19) United States
(12) Patent Application Publication
(10) Pub. No.: US 2014/0168093 A1
(43) Pub. Date: Jun. 19, 2014

(54) METHOD AND SYSTEM OF EMULATING PRESSURE SENSITIVITY ON A SURFACE

(71) Applicant: NVIDIA CORPORATION, Santa Clara, CA (US)

(72) Inventor: Philip Lawrence, Sunnyvale, CA (US)

(73) Assignee: NVIDIA CORPORATION, Santa Clara, CA (US)

(21) Appl. No.: 13/714,172

(22) Filed: Dec. 13, 2012

(51) Int. Cl. G06F 3/041

(52) U.S. Cl. CPC G06F 3/0414
USPC 345/173

(57) ABSTRACT

A system and method for emulating pressure-sensitivity are presented. Embodiments of the present invention provide a novel solution to generate emulated pressure data in response to contact made with a touch sensitive device, in that embodiments of the present invention expose more information about the contact in the form of location information of the contact, surface area data associated with the contact at the time contact was made, as well as a surface area data and calculated rates of change between the surface areas touched over time. In response to the input received, an emulated pressure computation module may then produce emulated pressure data which may be received by applications operable to utilize pressure input through an application programming interface coupling these applications to the emulation pressure computation module.

### FIELD OF THE INVENTION

Embodiments of the present invention are generally related to the field of touch sensitive display devices and user input devices.

### BACKGROUND OF THE INVENTION

Conventional touch sensitive display panels provide an electronic visual display that may detect the presence and location (i.e., coordinates) of touch input provided within the display area. These touch displays are commonly used within devices such as smartphones, tablet computers, laptops, desktop computers, and game consoles. Furthermore, these displays enable a user to provide direct input without the aid of other computer peripheral devices (e.g., keyboard, mouse) commonly used when a user interacts with content rendered by the display.

However, conventional touch sensitive displays are not inherently pressure-sensitive, in that they lack pressure sensors, and in that they utilize a hard surface (e.g., glass) which would inhibit pressure sensitivity. Devices which do offer pressure sensitivity rely primarily on mechanical methods of determining pressure-sensitive touch input from a user. For some surfaces, conventional methods of determining pressure data may prove too costly for manufacture.

### SUMMARY OF THE INVENTION

Accordingly, a need exists to address the inefficiencies discussed above. Embodiments of the present invention provide a novel solution to determine or simulate pressure data in response to contact made with a touch sensitive device, in that embodiments of the present invention expose more information about the user contact in the form of location information of the contact, surface area data associated with the contact at the time contact was made, as well as a calculated rate of change between the surface areas touched over time. In response to the input received, an emulated pressure computation module may then produce emulated pressure data which may be received by applications operable to utilize such pressure input through an application programming interface, for instance, coupling such applications to the emulated pressure computation module.

More specifically, in one embodiment, the present invention is implemented as a method of determining emulated pressure data derived from user contact with a touch-sensitive device. The method includes receiving an initial contact input, in which the initial contact input comprises initial surface area data calculated at an initial time. The method also includes receiving a subsequent contact input, in which the subsequent contact input comprises subsequent surface area data calculated at a subsequent time as well as generating a set of emulated pressure data based on the initial contact input and the subsequent contact input.

In one embodiment, the set of data includes a screen location coordinate and an emulated pressure value within a predetermined range in which the emulated pressure value is based on the rate of surface area change. In one embodiment, the predetermined range is determined based on a training session involving a user. In one embodiment, the training session establishes a low pressure threshold and a high pressure threshold.

In one embodiment, the method of generating further includes calculating a rate of surface area change comprising differences between the initial surface area data calculated at the initial time and the subsequent surface area data calculated at the subsequent time. In one embodiment, the initial contact input and the subsequent contact input are associated with a same user contact with a display panel of the touch-sensitive device. In one embodiment, the touch-sensitive device is a touch screen display device.

In another embodiment, the present invention is implemented as a system for determining emulated pressure data associated with contact with a touch-sensitive device. In one embodiment, the touch-sensitive device is a mobile device. The system includes a sensor operable to receive an initial contact input, in which the initial contact input comprises initial surface area data calculated at an initial time, and in which the sensor is further operable to receive a subsequent contact input, in which the subsequent contact input comprises subsequent surface area data calculated at a subsequent time. In one embodiment, the initial contact input and the subsequent contact input are associated with a same user contact with the sensor. The system also includes an electronic visual display source coupled adjacent to the sensor.

In one embodiment, the set of emulated pressure data comprises a screen coordinate and an emulated pressure value within a predetermined range in which the emulated pressure value is determined based on the rate of surface area change. In one embodiment, the predetermined range is based on a user training session.

The system also includes a computation module operable to generate a set of emulated pressure data based on the initial contact input and the subsequent contact input. In one embodiment, the computation module is further operable to calculate a rate of surface area change based on differences between the initial surface area data calculated at the initial time and the subsequent surface area data calculated at the subsequent time.

In yet another embodiment, the present invention is implemented as a non-transitory computer readable medium storing instructions that implement a method of determining emulated pressure data received from contact with a touch-sensitive device. The method includes receiving an initial contact input, in which the initial contact input comprises an initial surface area data calculated at an initial time.

The method also includes receiving a subsequent contact input, in which the subsequent contact input comprises subsequent surface area data calculated at a subsequent time as well as generating a set of emulated pressure data based on the initial contact input and the subsequent contact input. In one embodiment, the set includes a screen location coordinate and an emulated pressure value within a predetermined range in which the emulated pressure value is based on the rate of surface area change. In one embodiment, the predetermined range is determined based on a training session involving a user. In one embodiment, the training session establishes a low pressure threshold and a high pressure threshold.

In one embodiment, the method of generating further includes calculating a rate of surface area change comprising differences between the initial surface area data calculated at the initial time and the subsequent surface area data calculated at the subsequent time. In one embodiment, the initial contact input and the subsequent contact input are associated with a same user contact with a display panel of the touch-sensitive device. The method also includes communicating the set of emulated pressure data to an application using an application programming interface, in which the application is operable to generate a response based thereon.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 presents an illustration of a process of emulating pressure data in accordance to embodiments of the present invention.

FIG. 2 is a block diagram of an example computer system capable of implementing embodiments according to the present invention.

FIG. 3 is a flowchart of an exemplary computer-controlled method of emulating pressure data in an embodiment according to the present invention.

FIG. 4A provides an illustration of a method of determining emulated pressure data using a graphical user interface in accordance to embodiments of the present invention.

FIG. 4B provides another illustration of a method of determining emulated pressure data using a graphical user interface in accordance to embodiments of the present invention.

FIG. 4C provides an illustration of a method of determining emulated pressure data using audio signals in accordance to embodiments of the present invention.

FIG. 4D provides another illustration of a method of determining emulated pressure data using audio signals in accordance to embodiments of the present invention.

FIG. 4E provides an illustration of a method of determining emulated pressure data using haptic signals in accordance to embodiments of the present invention.

FIG. 4F provides another illustration of a method of determining emulated pressure data using haptic signals in accordance to embodiments of the present invention.

FIG. 4G provides an illustration of a method of determining emulated pressure data using multiple touch inputs in accordance to embodiments of the present invention.

FIG. 4H provides another illustration of a method of determining emulated pressure data using multiple touch inputs in accordance to embodiments of the present invention.

FIG. 4I provides another illustration of a method of determining emulated pressure data using multiple touch inputs in accordance to embodiments of the present invention.

FIG. 4J provides another illustration of a method of determining emulated pressure data using multiple touch inputs in accordance to embodiments of the present invention.

FIG. 5 provides a table depicting how emulated pressure data may be processed by embodiments of the present invention.

FIG. 6A provides an illustration of an exemplary application utilizing emulated pressure data in accordance to embodiments of the present invention.

FIG. 6B provides another illustration of exemplary application utilizing emulated pressure data in accordance to embodiments of the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

### An Exemplary Method of Emulating Pressure Sensitivity on a Surface

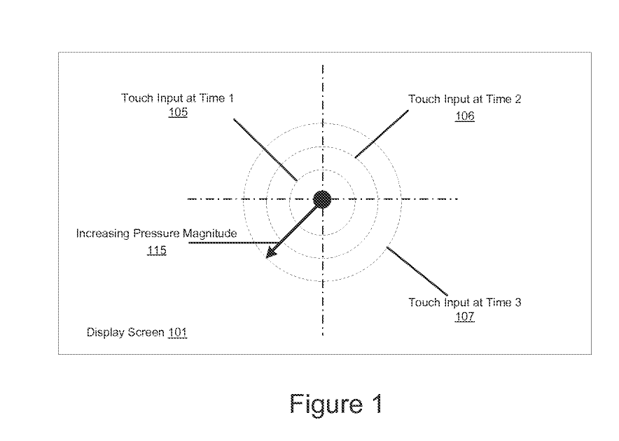

FIG. 1 provides an exemplary diagram of a pressure emulation process in accordance with embodiments of the present invention. FIG. 1 illustrates the manner in which embodiments of the present invention may capture information responsive to a user contact with a surface capable of processing touch input, for the purpose of generating emulated pressure data. Through the correlation of less pressure being analogous to smaller contact surface areas and more pressure being analogous to larger contact surface areas, embodiments of the present invention are operable to emulate pressure-sensitivity through the generation of pressure data via surface area calculation of the user contact at specified times and/or tracking the rate of change in the surface area.

As presented in FIG. 1, in one embodiment of the present invention, computer system 100 receives touch input captured at various times (e.g., touch input 105 captured at Time 1) on display screen 101. Touch input may be provided by sources such as fingertips or by instruments capable of providing a compressible form of contact with a surface (e.g., a stylus with a compressible tip). Furthermore, touch input may provide locational information (i.e., coordinates) regarding where contact is made with display screen 101 as well as surface area data associated with that contact at the time the contact was recorded.

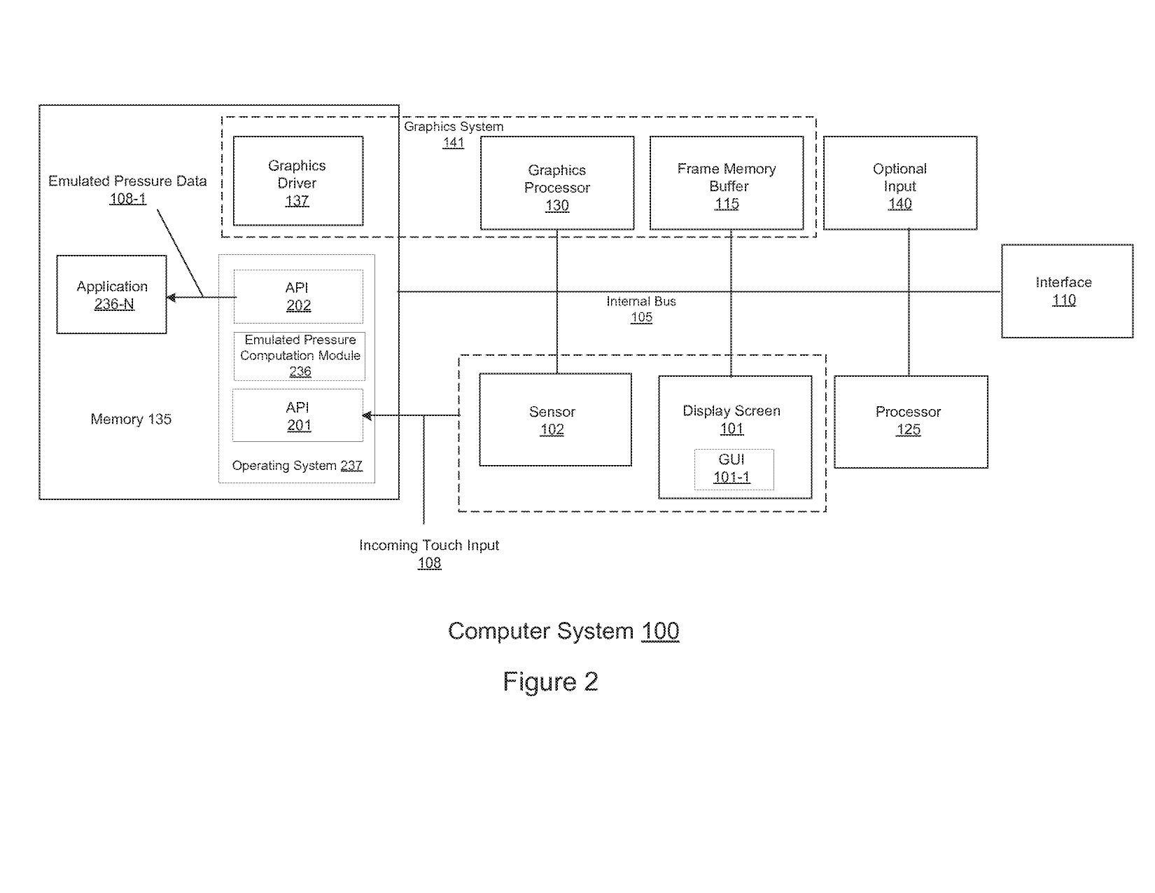

Touch input may be received through a sensor (e.g., sensor 102 in FIG. 2) or a plurality of sensors, which may be coupled to display screen 101 via a GUI (e.g., GUI 101-1 of FIG. 2). In one embodiment of the present invention, sensor 102 and display screen 101 may be the same device. Sensor 102 may be a substrate operable to determine locational information (e.g., coordinates within display screen 101) as well as the surface area associated with touch input (e.g., touch input 105) and/or the rate of change in contact surface area over time. In one embodiment, sensor 102 may be operable to capture multiple touch inputs simultaneously.

FIG. 1 further illustrates how embodiments of the present invention are operable to generate emulated pressure data in response to touch input provided by a user. FIG. 1 depicts how embodiments of the present invention capture touch inputs at subsequent time intervals after an initial touch input and generate emulated pressure data in response to the touch input received (e.g., in response to the finger becoming increasingly compressed to the sensor). FIG. 1 also illustrates how the surface areas calculated during their respective time periods correspond to actual pressure magnitude gradients created by increasing pressure magnitude 115.

As more physical pressure is applied to display screen 101, there is a corresponding increase in the surface area produced by the user contact (e.g., the finger becomes increasingly compressed to the sensor). In one embodiment, as less pressure is applied by a finger to display screen 101, there may be a corresponding decrease in the surface area produced by the touch input. After calculating the surface area data associated with touch input 105, sensor 102 further captures data associated with touch input 106 as well as touch input 107, which are both captured subsequent in time to touch input 105. Touch input 106 provides location information and surface area data captured at Time 2, while touch input 107 provides location information and surface area data captured at Time 3. As illustrated in FIG. 1, embodiments of the present invention may process these increasing surface areas and generate emulated pressure data reflecting the actual increasing pressure magnitude 115.

### Exemplary Computer System

As presented in FIG. 2, an exemplary computer system 100 upon which embodiments of the present invention may be implemented is depicted. Furthermore, exemplary computer system 100 may be implemented as a mobile device, laptop, desktop computer, or a server, or the like in accordance with embodiments of the present invention.

FIG. 2 illustrates how embodiments of the present invention utilize an application programming interface (“API”) software layer to communicate information responsive to touch inputs received at the hardware level (e.g., display screen 101 and/or sensor 102) to applications residing at the software level (e.g., application 236-N). In one embodiment, incoming touch input data 108 may comprise locational information, surface area data calculated at various time intervals, and/or the rate of change in the surface area. Furthermore, incoming touch input data 108 may be communicated to an operating system 237 residing in memory 135 via API 201.

In one embodiment of the present invention, emulated pressure computation module 236 may be a module within operating system 237 which stores values associated with incoming touch input 108 (e.g., coordinate values, surface area values, and timestamp values associated with each touch input received) for applications requesting the data (e.g., application 236-N). Furthermore, emulated pressure computation module 236 may use the values associated with incoming touch input 108 to calculate a rate of change in the surface areas from touch inputs received over time and generate based thereon a range of emulated pressure data in which each gradient within the range corresponds to the actual magnitude of pressure exerted on sensor 102 and/or display screen 101.

API 202 provides an interface between emulated pressure computation module 236 and the applications requesting pressure data received via GUI 101-1 (e.g., application 236-N). Through API 202, an application may map the emulated pressure data 108-1 produced by emulated pressure computation module 236 to correspond to a range of pressure data to be utilized by the application.

In one embodiment, emulated pressure computation module 236 may predetermine a range of possible emulated pressure data points through interactive “training sessions” in which a user may calibrate a device to recognize a specific range of pressure-sensitivity to be associated with a particular source (e.g., fingertip of index finger). Furthermore, training sessions may be application-specific or may be applied system-wide for all touch input interactions with a device (e.g., computer system 100).

Furthermore, computer system 100 includes processor 125 which processes instructions from application 236-N located in memory 135 to read data received from sensor 102 and/or display screen 101 and to store the data in frame memory buffer 115 for further processing via internal bus 105. Optionally, processor 125 may also execute instructions from operating system 237 located in memory 135. Optional input 140 includes devices that communicate user inputs from one or more users to computer system 100 and may include keyboards, mice, joysticks, and/or microphones. In one embodiment of the present invention, application 236-N represents a set of instructions that are capable of using user inputs such as touch screen input, in addition to peripheral devices such as keyboards, mice, joysticks, and/or microphones, or the like.

Interface 110 allows computer system 100 to communicate with other computer systems via an electronic communications network, including wired and/or wireless communication and including the Internet. Display screen 101 is any device capable of rendering visual information in response to a signal from computer system 100. Furthermore, display screen 101 may be any device coupled to computer system 100 capable of receiving user input via touch input from one or more users. In one embodiment, interface 110 may communicate emulated pressure data generated by emulated pressure computation module 236 to other remote devices over a network.

Optional graphics system 141 comprises graphics driver 137, graphics processor 130 and frame memory buffer 115. Graphics driver 137 is operable to assist optional graphics system 141 in generating a stream of rendered data by providing configuration instructions to graphics processor 130. Graphics processor 130 may process instructions from application 236-N to read data that is stored in frame memory buffer 115 and to send data to processor 125 via internal bus 105 for rendering the data on display screen 101. Graphics processor 130 generates pixel data for output images from rendering commands and may be configured as multiple virtual graphic processors that are used in parallel (concurrently) by a number of applications, such as application 236-N, executing in parallel.

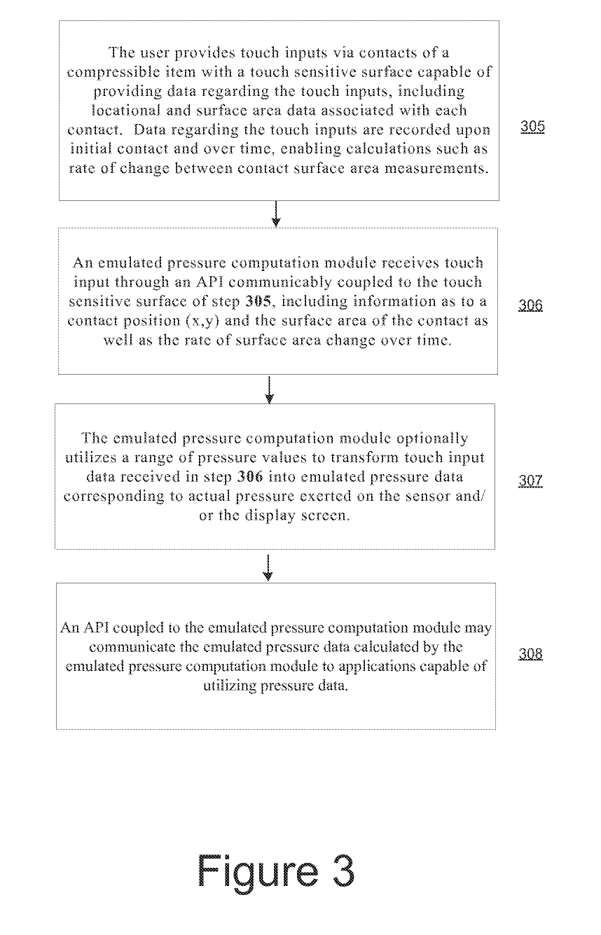

FIG. 3 provides a flow chart depicting an exemplary pressure data emulation process in accordance with embodiments of the present invention.

At step 305, the user provides touch inputs via contacts of a compressible item (e.g., a fingertip) with a touch sensitive surface capable of providing data regarding the touch inputs, including locational and surface area data associated with each contact. Data regarding the touch inputs are recorded upon initial contact and over time, enabling calculations such as rate of change between contact surface area measurements.

At step 306, an emulated pressure computation module receives touch input through an API communicably coupled to the touch sensitive surface of step 305, including information as to a contact position (“coordinate”) and the surface area of the contact as well as the rate of surface area change over time.

At step 307, the emulated pressure computation module optionally utilizes a range of possible pressure values (e.g., gathered via interactive “training sessions”) to transform touch input data received in step 306 into emulated pressure data corresponding to actual pressure exerted on the sensor and/or the display screen.

At step 308, an API coupled to the emulated pressure computation module may communicate the emulated pressure data calculated by the emulated pressure computation module to applications capable of utilizing pressure data.

### Exemplary Emulated Pressure Training Sessions

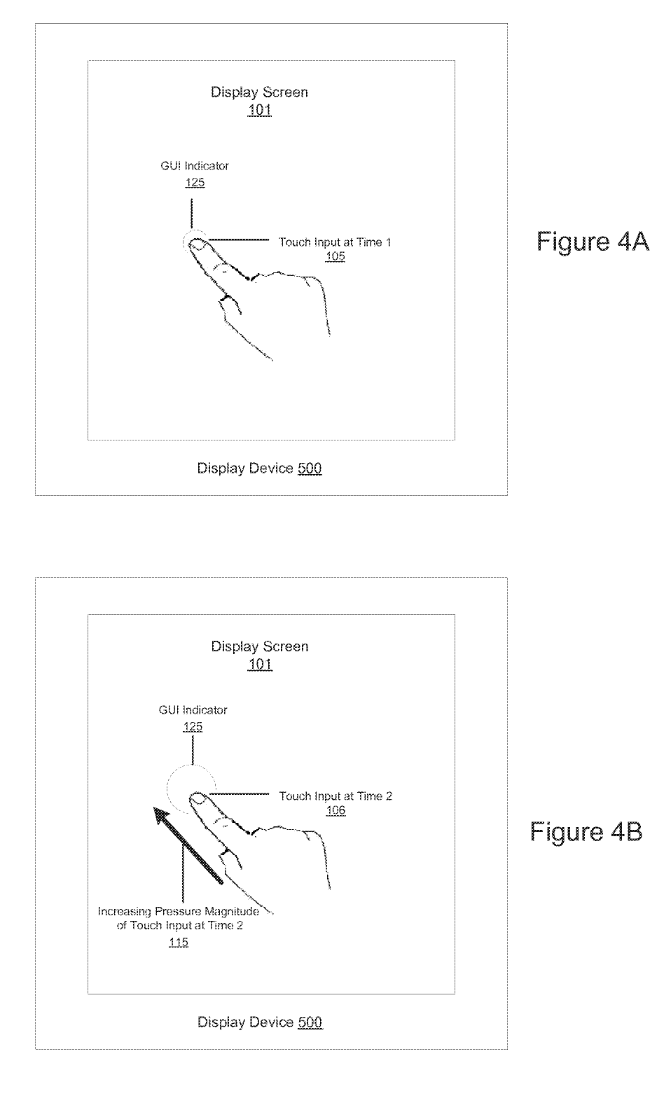

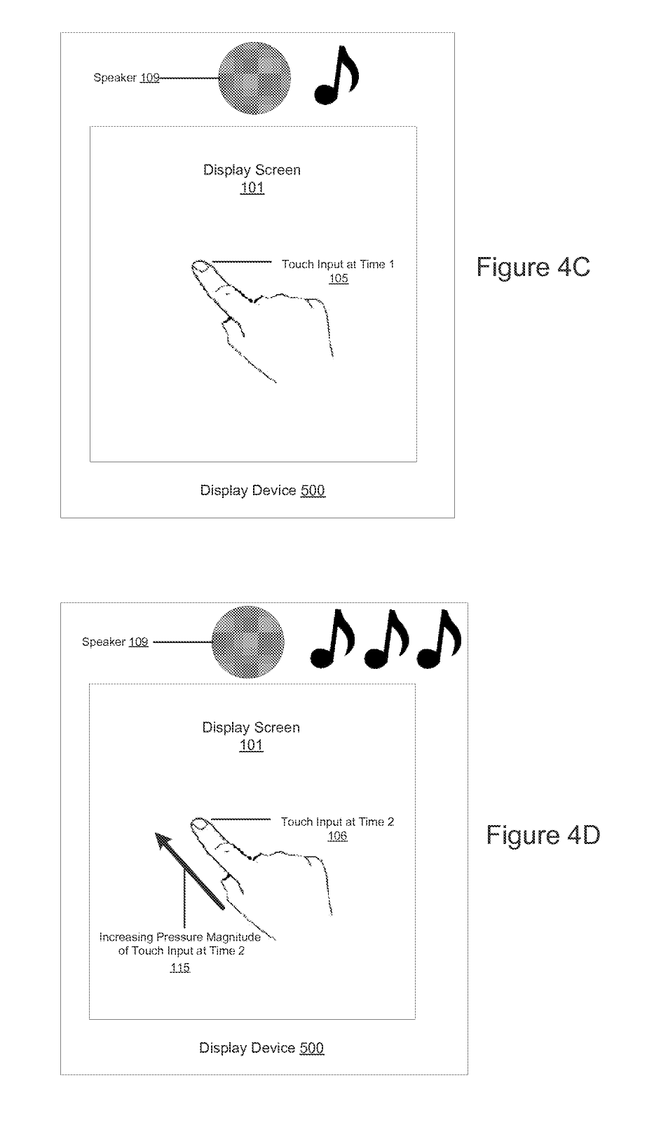

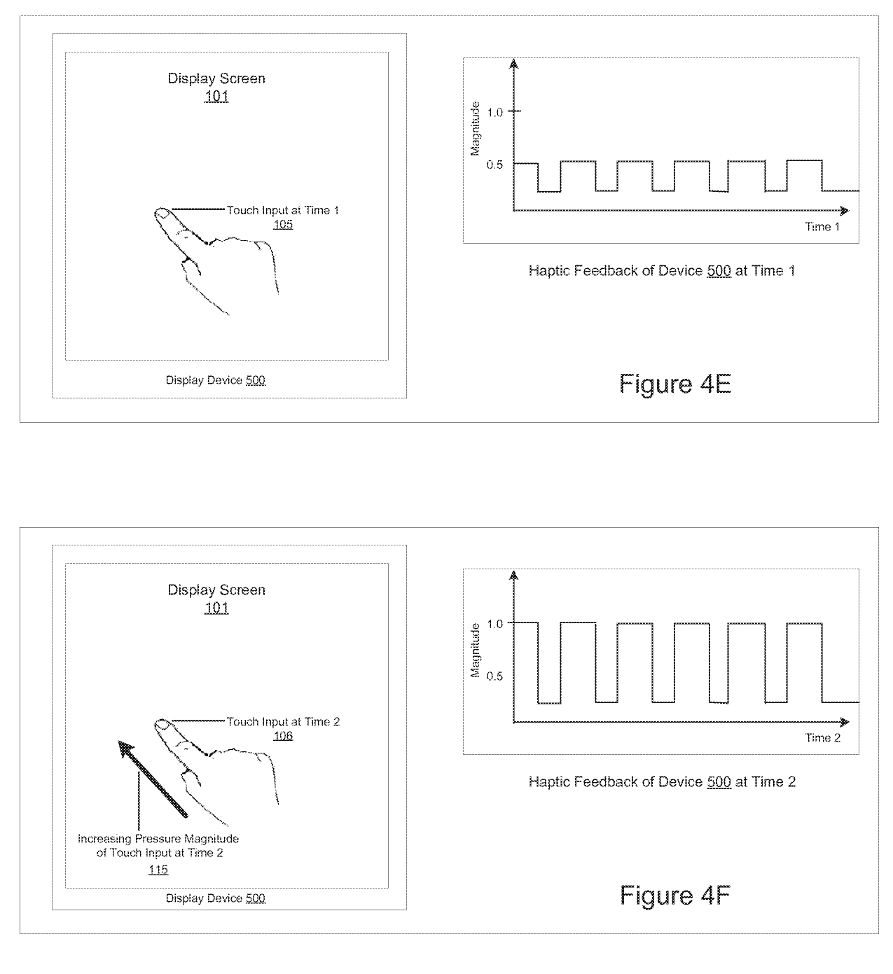

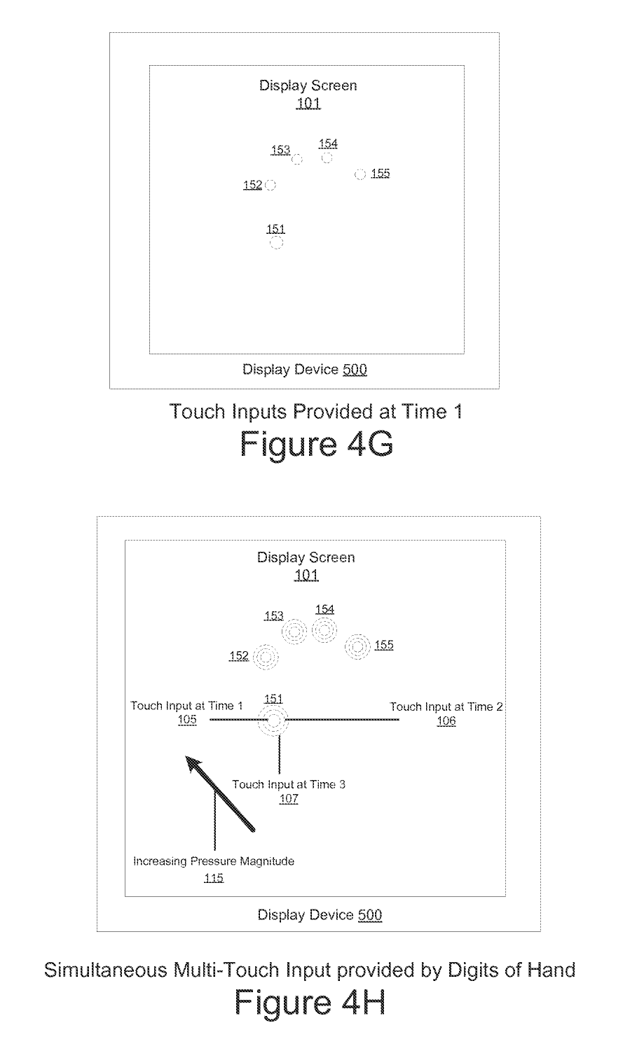

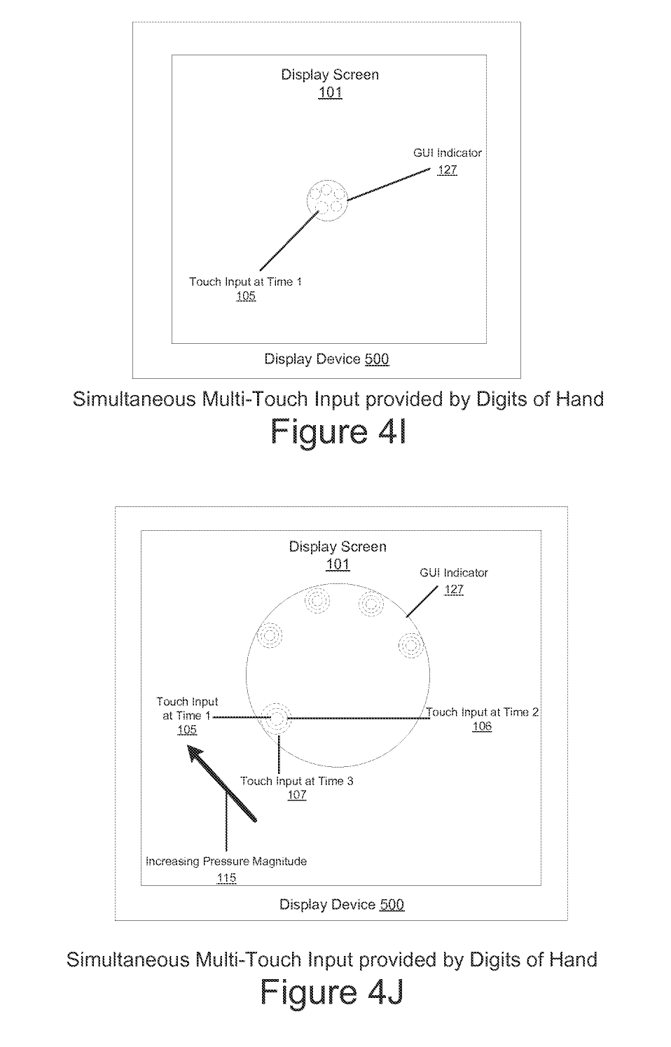

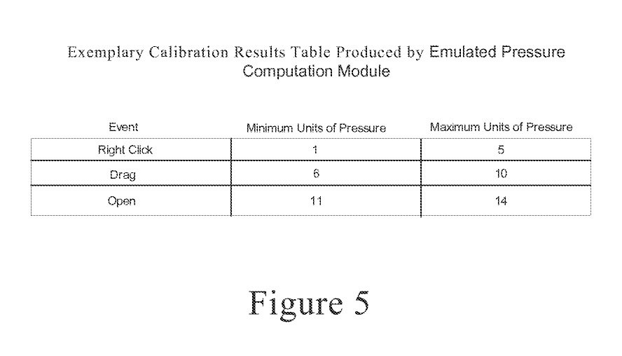

FIG. 4A illustrates an exemplary training session using visual calibration techniques through a graphical user interface in accordance with embodiments of the present invention. FIG. 4A illustrates a scenario in which a user may calibrate a display device (e.g., display device 500) similar to computer system 100 to recognize the pressure-sensitivities of a specific source (e.g., the fingertip of the user's index finger). In one embodiment, emulated pressure computation module 236 may calculate an emulated minimum pressure corresponding to display device 500 receiving a light touch input, whereas an emulated maximum pressure may be computed to correspond to the maximum surface area that the user's fingertip is capable of touching on the surface.

As illustrated in FIG. 4A, in determining the minimum emulated pressure value, the user may first place the index fingertip on display screen 101, providing at least the minimum amount of pressure required for sensors coupled to display screen 101 (e.g., sensor 102) to detect the initial contact made with display screen 101. The user may recognize that display device 500 registers this initial contact made with display screen 101 through the use of visual aids provided on a graphical user interface, such as a circle (e.g., GUI indicator 125) appearing around the point of contact made by touch input 105 at Time 1. The minimum emulated pressure value is then stored.

As FIG. 4B further illustrates, the more pressure asserted by the user via the index finger, i.e. the more the pressure magnitude 115 applied to display screen 101 increases, the more the finger is compressed against the interface. In correspondence with this increase in pressure magnitude 115, emulated pressure computation module 236 transforms the increasing touch input surface area, captured at various times during the training session (e.g., touch input 106 captured at Time 2), into corresponding emulated pressure data points. Furthermore, the GUI indicator 125 may provide instantaneous visual feedback regarding this calibration process in the form of GUI indicator 125 growing in size in correspondence with the recognition of increasing pressure magnitude 115, until the user submits the maximum surface area that may be provided by the user's index finger. In one embodiment, emulated pressure computation module 236 may establish this maximum threshold by detecting no further increases in surface area during the training session or, alternatively, through decreases in surface area after a particular emulated pressure data point has been reached. The maximum and minimum surface areas encountered in this training session are thus used to create and store a range of possible emulated pressure data.

FIG. 4C illustrates an exemplary training session in which audio calibration techniques are used in accordance with embodiments of the present invention. Similar to FIG. 4A, FIG. 4C illustrates a scenario in which a user may wish to calibrate computer system 100 to recognize the pressure-sensitivities of a specific source (e.g., the fingertip of the user's index finger). In one embodiment, emulated pressure computation module 236 may calculate an emulated minimum pressure corresponding to display device 500 receiving a light touch input, whereas an emulated maximum pressure may be computed to correspond to the maximum surface area that the user's fingertip is capable of touching on the surface.

As illustrated in FIG. 4C, in determining the minimum emulated pressure value, the user may first place the index fingertip on display screen 101, providing at least the minimum amount of pressure required for sensors coupled to display screen 101 (e.g., sensor 102) to detect the initial contact made with display screen 101. The user may recognize that display device 500 registers this initial contact made with display screen 101 through the use of audio signals provided through conventional audio rendering methods. In one embodiment, for instance, a perceptible audio signal may sound (e.g., audio emitted from speakers 109) once contact is made by touch input 105 at Time 1. The minimum emulated pressure value is then stored.

As FIG. 4D further illustrates, the more pressure asserted by the user via the index finger, i.e. the more the pressure magnitude 115 applied to display screen 101 increases, the more the finger is compressed against the interface. In correspondence with this increase in pressure magnitude 115, emulated pressure computation module 236 transforms the increasing touch input surface area, captured at various times during the training session (e.g., touch input 106 captured at Time 2), into corresponding emulated pressure data points. Furthermore, the audio emitted from speaker 109 may provide instantaneous audio feedback regarding this calibration process in the form of audio tones increasing in volume in correspondence with the recognition of increasing pressure magnitude 115, until the user submits the maximum surface area that may be provided by the user's index finger. In one embodiment, emulated pressure computation module 236 may establish this maximum threshold by detecting no further increases in surface area during the training session or, alternatively, through decreases in surface area after a particular emulated pressure data point has been reached. The maximum and minimum surface areas encountered in this training session are thus used to create and store a range of possible emulated pressure data.

FIG. 4E illustrates an exemplary training session using haptic calibration techniques in accordance with embodiments of the present invention. Similar to the previous figures, FIG. 4E illustrates a scenario in which a user may wish to calibrate computer system 100 to recognize the pressure-sensitivities of a specific source (e.g., the fingertip of the user's index finger). In one embodiment, emulated pressure computation module 236 may calculate an emulated minimum pressure corresponding to display device 500 receiving a light touch input, whereas an emulated maximum pressure may be computed to correspond to the maximum surface area that the user's fingertip is capable of touching on the surface.

As illustrated in FIG. 4E, in determining the minimum emulated pressure value, the user may first place the index fingertip on display screen 101, providing at least the minimum amount of pressure required for sensors coupled to display screen 101 (e.g., sensor 102) to detect the initial contact made with the display screen 101. The user may recognize that display device 500 registers this initial contact made with display screen 101 through the use of vibrations provided through conventional haptic signal generation methods (e.g., actuators communicably coupled to display device 500). In one embodiment, for instance, the user may feel a perceptible vibration once contact is made by touch input 105 at Time 1 (as depicted in the graph of haptic feedback of device 500 at Time 1). The minimum emulated pressure value is then stored.

As FIG. 4F further illustrates, the more pressure asserted by the user via the index finger, i.e. the more the pressure magnitude 115 applied to display screen 101 increases, the more the finger is compressed against the interface. In correspondence with this increase in pressure magnitude 115, emulated pressure computation module 236 transforms the increasing touch input surface area captured at various times during the training session (e.g., touch input 106 captured at Time 2) into corresponding emulated pressure data points. Furthermore, the vibrations may provide instantaneous haptic feedback regarding this calibration process in the form of vibrations increasing in magnitude in correspondence with the recognition of increasing pressure magnitude 115, until the user submits the maximum surface area that may be provided by the user's index finger (as depicted in the graph of haptic feedback of device 500 at Time 2).

In one embodiment, emulated pressure computation module 236 may establish this maximum threshold by detecting no further increases in surface area during the training session or, alternatively, through decreases in surface area after a particular emulated pressure data point has been reached. The maximum and minimum surface areas encountered in this training session are thus used to create and store a range of possible emulated pressure data.

Although FIGS. 4A-4F illustrate training sessions involving the user's index finger, embodiments of the present invention may be trained to recognize the pressure sensitivities of various items, such as any digit of the hand separately, or any part of the body, such as one's nose, or any compressible tool, such as a stylus with a compressible tip.

FIG. 4G illustrates yet another exemplary training session in accordance with embodiments of the present invention and illustrates how embodiments of the present invention may generate emulated pressure data based on simultaneous contact made by multiple discrete touch inputs with display screen 101. FIG. 4G illustrates a scenario in which a user may wish to train computer system 100 to recognize the pressure-sensitivities associated with multiple concurrent touch input sources (e.g., all digits of the user's hand) as they apply simultaneous pressure on display screen 101. In one embodiment, computer system 100 may be trained to still recognize each discrete input independently. In one embodiment, computer system 100 may be trained to recognize the pressure of all discrete inputs collectively.

For instance, embodiments of the present invention may be configured such that emulated pressure computation module 236 may consider the sum of discrete surface areas of all simultaneous touch inputs when calculating emulated pressure data. In determining emulated pressure data in this manner, embodiments of the present invention may still track each discrete touch input's individual changes in surface area, which may contribute to the overall surface area calculation.

As discussed in previous embodiments, emulated pressure computation module 236 may calculate a minimum emulated pressure corresponding to display device 500 receiving a light touch input. In one embodiment, a maximum emulated pressure may correspond with the sum of the maximum amount of surface area each discrete touch input is individually capable of generating.

As illustrated in FIG. 4G, in determining the minimum threshold, the user may rest one fingertip of the user's hand on display screen 101 providing at least a minimum amount of pressure to the extent that sensors coupled to display screen 101 (e.g., sensor 102) detect contact made with the fingertip on the display screen 101. As discussed supra, the user may recognize that display device 500 registers the initial contact made with display screen 101 through the use of visual aids provided on a graphical user interface, such as a shape (e.g., circle or ellipse) appearing around the point of contact. In one embodiment, the user may see the shape displayed on the graphical user interface on display screen 101, depicting the detection of the input (e.g. GUI indicator 152).

As illustrated in FIG. 4G, the user may further rest more fingertips of the user's hand on display screen 101, each providing at least a minimum amount of pressure to the extent that sensors coupled to display screen 101 (e.g., sensor 102) detect contact made with each fingertip on the display screen 101. As discussed supra, the user may recognize that display device 500 registers each additional contact made with display screen 101 through the use of visual aids provided on a graphical user interface, such as a shape (e.g., circle or ellipse) appearing around each individual point of contact made by each additional touch input (e.g., fingertips of each digit making contact). In one embodiment, the user may see the shapes displayed on the graphical user interface on display screen 101, depicting the detection of each additional input (e.g. GUI indicators 151, 153, 154, 155). Emulated pressure computation module 236 may calculate the additional surface area captured from each additional touch and correlate the data into corresponding emulated pressure data points, i.e., into a corresponding increase in total emulated pressure.

With reference to FIG. 4H, as each discrete touch input provides more pressure and the corresponding digit further compresses against display screen 101, the shapes encapsulating each area of simultaneous contact made by the digits increases its circumference. Emulated pressure computation module 236 may calculate the increasing surface areas captured at various times during the training session and correlate the data into corresponding emulated pressure data points.

Furthermore, emulated pressure computation module 236 calculates the increasing pressure magnitude 115 provided by each discrete touch input (e.g., touch inputs 105 through 107 provided by the user's thumb, captured at their respective times) until the user submits the maximum surface area possible associated with the fingertips of each digit. In one embodiment, the GUI indicator 126 may provide instantaneous visual feedback of the shapes growing in size in correspondence with the increasing pressure magnitude 115. Furthermore, in one embodiment, emulated pressure computation module 236 may establish this maximum threshold by detecting no further increases in surface areas during the training session or decreases in surface areas after a particular emulated pressure data point.

FIG. 4I further illustrates how both the placement and compression of a set of discrete touch inputs may produce emulated data in accordance with embodiments of the present invention. As depicted in FIG. 4I, each digit of the user's hand may be initially placed close together when pressure is applied to display screen 101. As such, the surface area of this “collective touch input” captured by display device 500 may be considered to be bounded by the circumference of the smallest shape (e.g. ellipse or circle) possible that encapsulates the entire group of discrete touch inputs. In a manner similar to embodiments described herein, the user may recognize that display device 500 registers the initial contact made with display screen 101 through the use of visual aids provided on a graphical user interface, such as a shape (e.g., circle or ellipse) appearing around the collective touch input (e.g., fingertips of all digits making contact). In one embodiment, the user may see the shape displayed on the graphical user interface on display screen 101, depicting the grouping of the detected set of discrete inputs (e.g. GUI indicator 127).

With reference to FIG. 4J, as the digits spreads apart, the circumference of the smallest shape capable of encapsulating the concurrent contacts made by each digit with display screen 101 increases. Emulated pressure computation module 236 calculates the increasing surface area of this collective touch input, captured at various times during the training session, and correlates the data into corresponding emulated pressure data points. The circumference of the smallest shape capable of encapsulating the concurrent contacts is also expanded as the touched surface area of each digit enlarges due to increasing pressure magnitude 115. Furthermore, in one embodiment, GUI indicator 127 may provide instantaneous visual feedback by expanding in size in correspondence with the increasing distance between the concurrent contacts made by each digit, and in correspondence with increasing pressure magnitude 115. Similar to previous embodiments described herein, emulated pressure computation module 236 may established a maximum threshold by detecting no further increases in surface area during the training session or decreases in surface area after a particular emulated pressure data point.

Although FIGS. 4A-4J illustrate training sessions involving the user's fingertips, embodiments of the present invention may be trained to recognize other pressure sources making contact with a touch-sensitive surface as a collective touch input (e.g., the pressure sensitivities of the user's palm and finger surfaces when the entire hand is laid flat against a touch sensitive surface).

Also, although FIGS. 4A-4J illustrates separate training sessions, these sessions may be used in combination for calibrating a system or application. Furthermore, embodiments of the present invention support multiple users providing touch input using the same display screen or multiple display screens at the same time or providing touch input remotely to emulated pressure computation module 236 over a network.

Furthermore, it should be appreciated that although FIGS. 4A-4J depict various types of training sessions for calibrating a touch sensitive device, embodiments of the present invention do not necessarily require the use of these sessions. Embodiments may use surface area and/or rate of surface area change calculations to calculate emulated pressure as described herein.

### Exemplary Applications Incorporating Derived Emulated Pressure

FIG. 5 presents an exemplary application of utilizing emulated pressure data in accordance with embodiments of the present invention. FIG. 5 provides an exemplary calibration results table which represents the minimum and maximum thresholds of each GUI event calibrated by a user, as computed by emulated pressure computation module 236.

FIG. 5 illustrates an embodiment in which the user trains a device with an aforementioned system-wide training session which calibrates the device to recognize the pressure-sensitivities of a specified source (e.g., the user's index finger) to perform common events on an on-screen GUI (i.e., right-clicking an item, dragging an item, and opening an item). Upon completion of the training session, embodiments of the present invention may be able to generate a range of pressure data in which each gradient within the range corresponds to emulated pressure derived by emulated pressure computation module 236. Therefore, a user may associate a particular GUI event to a specific threshold range of emulated pressure derived by emulated pressure computation module 236.

For instance, in one embodiment, the user may wish to train for an event analogous to “right-clicking” on an object using a mouse to gather more information about the object or to be provided with more options to perform other actions on the object of interest. The user may then specify a pressure threshold (e.g., between 1-5 units of pressure). Therefore, anything below 1 or above 5 units of pressure would cause the device to not recognize that the user wishes to perform a “right-click” event. Therefore, a user wishing to “right-click” on an item (e.g., wishing to learn more about a folder or generating a list of actions that may be performed on a folder) must apply pressure within the defined range of 1-5 units of pressure.

Similarly, the user may wish to train for the event of “dragging” an item on the display to require a pressure threshold between 6-10 units of pressure. Therefore, anything below 6 or above 10 units of pressure would cause the device to not recognize that the user wishes to perform a “dragging” event. Therefore, a user wishing to drag an item on a display (e.g., dragging a file folder from one location on the GUI to another), must apply pressure within the defined range of 6-10 units of pressure.

Furthermore, the user may wish to train for the event of “opening” an item on the display to require a pressure threshold between 11-14 units of pressure. Therefore, anything below 11 or above 14 units of pressure would cause the device to not recognize that the user wishes to perform an “opening” event. Therefore, a user wishing to open an item on a display (e.g., opening a file folder from the GUI), must apply pressure within the defined range of 11-14 units of pressure).

Although FIG. 5 illustrates calibration of events typically associated with using a mouse, embodiments of the present invention may also be configured with regard to events typically associated with other computer peripheral devices.

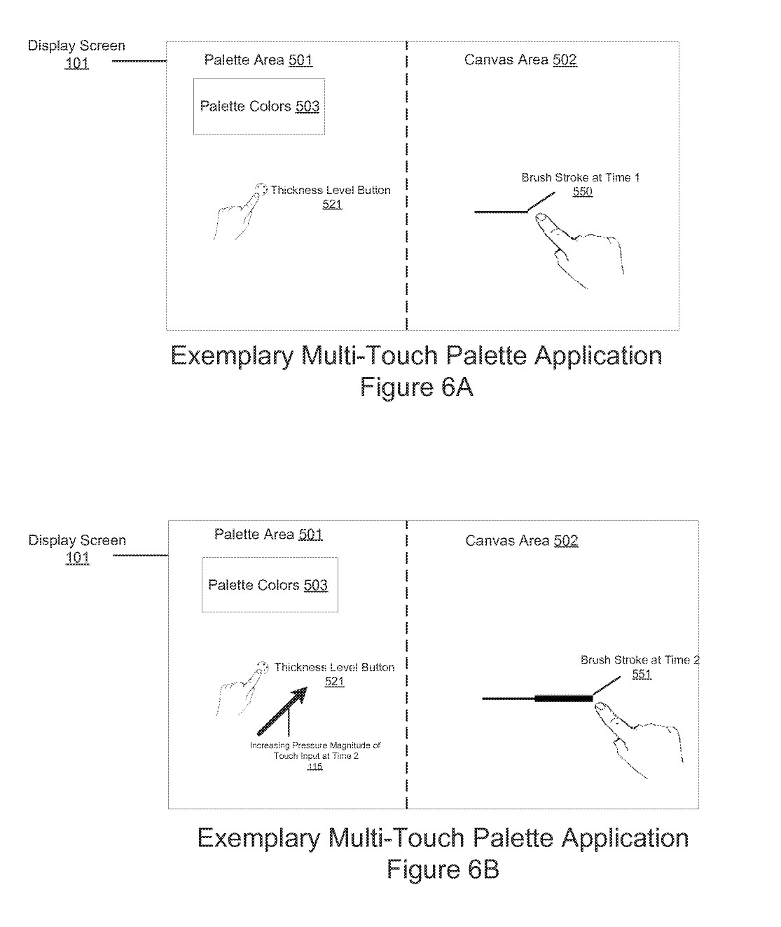

FIGS. 6A and 6B present yet another exemplary application using emulated pressure data in accordance with embodiments of the present invention. FIGS. 6A and 6B illustrate an embodiment in which an application utilizes emulated pressure data from one touch input (e.g., pointer finger of left hand) while not utilizing emulated pressure data provided by another source (e.g., pointer finger of right hand). As discussed herein, for these applications, embodiments of the present invention may be configured to determine emulated pressure data by encapsulating the touch region surrounding the sources providing touch input and then calculating the surface area and/or the rate of change of the region so encapsulated.

Upon completion of an aforementioned training session, embodiments of the present invention may be able generate a range of pressure data in which each gradient within the range corresponds to emulated pressure derived by emulated pressure computation module 236. Therefore, for an application capable of responding to multiple touch inputs, a user may associate application-specific events to a specific threshold range of emulated pressure derived by emulated pressure computation module 236.

FIGS. 6A and 6B present an exemplary painting application which is capable of responding to multi-touch input in accordance with embodiments of the present invention. The application divides display screen 101 such that one portion of the screen is designated as a “palette” area in which the user may select colors and apply various levels of brush stroke thickness, while another portion of the screen is designated as the “canvas” area in which the user may paint lines, draw objects, etc.

As depicted in FIG. 6A, the user may calibrate the user's right index finger to behave as a “brush” painting lines within a non-pressure sensitive canvas area 502 (i.e. only touch coordinate data will be used in canvas area 502), while the left index finger may select colors from palette colors box 503 and select the thickness level of lines painted by the user's right index finger using thickness level button 521. For instance, thickness level button 521 may be trained for specific thresholds regarding the level of thickness regarding the brush stroke. Given the initial pressure applied on thickness level button 521, brush stroke thickness 550 at Time 1 appears to paint a thin line. However, as depicted in FIG. 6B, as a user applies an increased pressure on thickness level button 521 during Time 2, brush stroke 551 may be applied as a thicker line within canvas area 502.

In another embodiment of the present invention, a user may train a device with an aforementioned system-wide training session which calibrates a device to recognize the pressure-sensitivities of a specified source (e.g., the user's index finger) to perform an event on a device not coupled to visual display source (e.g., pressure-sensitive light display wall panel). Upon completion of the training session (likely a haptic or an audio training session, given the lack of a visual display), embodiments of the present invention may be able generate a range of pressure data in which each gradient within the range corresponds to emulated pressure derived by emulated pressure computation module 236. In a manner similar to that employed with devices coupled to a visual display source, a user may correlate actions with specific levels of emulated pressure derived by emulated pressure computation module 236. For instance, in one embodiment, the user may establish various illumination levels in which a light display coupled to the pressure-sensitive wall panel may increase or decrease the level of brightness in response to emulated pressure thresholds established via training session provided by embodiments of the present invention.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above disclosure. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A method of determining emulated pressure data derived from user contact with a touch-sensitive device, said method comprising:
receiving an initial contact input, wherein said initial contact input comprises initial surface area data calculated at an initial time;
receiving a subsequent contact input, wherein said subsequent contact input comprises subsequent surface area data calculated at a subsequent time;
generating a set of emulated pressure data based on said initial contact input and said subsequent contact input; and
using a display device, contemporaneously providing feedback to a user for each value of said set of emulated pressure produced during said generating step.

2. The method as described in claim 1, wherein said generating further comprises:
calculating a rate of surface area change comprising differences between said initial surface area data calculated at said initial time and said subsequent surface area data calculated at said subsequent time.

3. The method as described in claim 1, wherein said initial contact input and said subsequent contact input are associated with a same user contact with a display panel of said touch-sensitive device.

4. The method as described in claim 3, wherein said touch-sensitive device is a touch screen display device.

5. The method as described in claim 1, wherein said subsequent contact input represents a maximum pressure-sensitive input threshold.

6. The method as described in claim 1, wherein said set of emulated pressure data is generated during a training session involving said user.

7. The method as described in claim 6, wherein said training session comprises capturing data separately from a stylus, an individual digit or from an entire hand.

8. The method as described in claim 1, wherein said providing feedback further comprises providing audio feedback.

9. A system for determining emulated pressure data associated with contact with a touch-sensitive device, said system comprising:
a sensor operable to receive an initial contact input, wherein said initial contact input comprises initial surface area data calculated at an initial time, wherein said sensor is further operable to receive a subsequent contact input, wherein said subsequent contact input comprises subsequent surface area data calculated at a subsequent time;
a computation module operable to generate a set of emulated pressure data based on said initial contact input and said subsequent contact input; and
an electronic visual display source coupled adjacent to said sensor, wherein said electronic visual display source is operable to contemporaneously provide feedback to a user for each value of said set of emulated pressure generated by said computation module.

10. The system as described in claim 9, wherein said computation module is further operable to calculate a rate of surface area change, based on differences between said initial surface area data calculated at said initial time and said subsequent surface area data calculated at said subsequent time.

11. The system as described in claim 9, wherein said initial contact input and said subsequent contact input are associated with a same user contact with said sensor.

12. The system as described in claim 9, wherein said touch-sensitive device is a mobile device.

13. The system as described in claim 9, wherein said subsequent contact input represents a maximum pressure-sensitive input threshold.

14. The system as described in claim 9, wherein said set of emulated pressure data is generated during a training session involving said user.

15. The system as described in claim 9, wherein said providing feedback further comprises providing audio feedback.

16. A non-transitory computer readable medium for storing instructions that implement a method of determining emulated pressure, said method comprising:
receiving an initial contact input, wherein said initial contact input comprises initial surface area data calculated at an initial time;
receiving a subsequent contact input, wherein said subsequent contact input comprises subsequent surface area data calculated at a subsequent time;
generating a set of emulated pressure data based on said initial contact input and said subsequent contact input;
using a display device, contemporaneously providing feedback to a user for each value of said set of emulated pressure produced during said generating step; and
communicating said set of emulated pressure to an application using an application programming interface, wherein said application is operable to generate a response based thereon.

17. The computer readable medium as described in claim 16, wherein said generating further comprises:
calculating a rate of surface area change comprising differences between said initial surface area data calculated at said initial time and said subsequent surface area data calculated at said subsequent time.

18. The computer readable medium as described in claim 16, wherein said initial contact input and said subsequent contact input are associated with a same user contact with a display panel of said touch-sensitive device.

19. The computer readable medium as described in claim 16, wherein said set of emulated pressure data is generated during a training session involving said user.

20. The computer readable medium described in claim 19, wherein said training session comprises capturing data separately from a stylus, an individual digit or from an entire hand.

21. The computer readable medium described in claim 16, wherein said providing feedback further comprises providing haptic feedback.
